(19) United States
(12) Patent Application Publication
(10) Pub. No.: US 2004/0048674 A1
(43) Pub. Date: Mar. 11, 2004

(54) Video display unit for video game console

(75) Inventors: Saied Hussaini, Miami, FL (US); Marc Iacovelli, Miami, FL (US)

Correspondence Address: Liniak, Berenato, Longacre & White, Ste. 240, 6550 Rock Spring Drive, Bethesda, MD, 20817, US

(73) Assignee: INTEC, INC.

(21) Appl. No.: 10/600,566

(22) Filed: Jun. 23, 2003

Related U.S. Application Data
(63) Continuation-in-part of application No. 10/237,054, filed on Sep. 9, 2002.

(51) Int. Cl. A63F 13/00

(52) U.S. Cl. 463/46

(57) ABSTRACT

A portable video display unit is adapted for use with various electronic video-processing devices, such as video game consoles and video players (DVD players). The video display unit includes a base member adapted for removably attaching the video display unit to the electronic video processing device. The base member includes a locking device to securely affix the video display to the game console and permit portability while attached. A display screen is pivotally mounted to the base member for pivoting between a stowed position and a deployed position which is viewable by a user of the electronic video processing device.

This application is a continuation in part application of U.S. Ser. No. 10/237,054 filed on Sep. 9, 2002 entitled Video Display Unit for Video Game Console and is hereby incorporated herein by reference.

### BACKGROUND OF THE INVENTION

1. Field of the Invention

The present invention relates to consumer electronics, and more particularly to a detachable, compact screen apparatus for an electronic video-processing device, such as a video game console.

2. Description of the Prior Art

Various electronic video-processing devices, such as video game consoles, video players (DVD players or VCRs), etc., are becoming more and more popular. Usually, they include a box-shaped casing provided with as plurality of female plugs for interconnecting to two or more respective control units, a TV monitor and a power adapter. Typically, the electronic video-processing devices are sold separately, without a dedicated display screen, and are adapted to work with conventional TV monitors. Therefore, when children without a TV in their rooms are playing video games or using the video player, they are tying family TV monitors, precluding other household members from watching regular TV shows.

Thus, there is a need for a compact, portable video screen unit adapted to be used with the electronic video-processing devices, in particular with the video game consoles, such as video game systems manufactured by SONY®, such as PlayStation®2, NINTENDO®, such as GAMECUBE, or Microsoft® such as the X-Box.

### SUMMARY OF THE INVENTION

The present invention provides a novel, portable video display unit for various electronic video-processing devices, especially for video game consoles and video players.

In accordance with the present invention, the portable video screen unit is specifically adapted to be used with the X-Box® video game console manufactured by Microsoft Corp. and comprises a base member adapted to be removably attached to the X-Box® video game console, and a video display member pivotably mounted on the base member for rotation between a stowed position and a deployed position.

The base member includes a substantially flat base panel, and a screen support member integrally formed with and upwardly extending from a top surface of the base panel adjacent to a rear edge thereof and extending substantially parallel thereto. The screen support member has a front control panel provided with a power switch, a volume control, a screen brightness control, a screen color control, and an earphone plug socket, and a rear panel provided with an S-video input socket, a video input socket, two audio input sockets, a composite audio/video output, and a socket for a DC/AC adapter.

The base panel of the base member further includes a locking attachment device provided for removably securing the video display unit to the video game console. The screen mounting device for the X-Box® video game console includes a guide flange, a mounting flange having tab members, and a rear flange having rear locking tabs.

The guide flange extends downwardly from a bottom surface of the base panel substantially perpendicularly thereto and is formed along a side edge thereof. The guide flange frictionally engages the side face of the casing of the video game console.

The mounting flange extends downwardly from the bottom surface of the base panel substantially perpendicularly thereto and is formed along the side edge thereof. The mounting flange of the present invention includes at least one mounting rib formed substantially complementary to grooves provided on a front side face of the casing of the video game console. Preferably, the mounting rib is formed of two front tab members adapted to appropriately position the base panel of the video display unit relative to the front face of the casing of the X-Box® video game console. The front tab members are formed at the opposite ends of the front edge of the base panel and extend inwardly to engage a grooved recess formed in the front of the video console.

Preferably, the base panel is homogeneously formed of strong and durable plastic material as a unitary body integrally with the tab members, thus alleviating the cost of assembling multiple components and simplifying its manufacture.

The rear locking tab is pivotally mounted at the rear edge of the base panel for rotation in a plane substantially perpendicular to the rear edge. The locking tab is of generally L-shaped configuration and has a locking mechanism adapted to lock the position of the locking tab once engaged with the video game console. The locking tab releasably latches the video display unit onto the video game console in a discrete predetermined position with respect thereto.

The video display member includes a hollow display casing pivotally mounted to the screen support member. The display casing houses a display screen. Preferably, the display screen is a substantially flat liquid crystal display (LCD) screen. The display casing further houses a pair of built-in stereo speakers located on both sides of the LCD screen for providing a stereo sound. The video display member can flip up and tilt to the preference of the player to view the screen in the deployed position, or fold down on top of the flat base panel of the base member when not in use for easy storage in the stowed position.

In use, the video display unit is attached to the video game console by sliding the base panel over the top surface of the casing from the front face to the rear face thereof so that mounting tabs slide into the grooved recesses provided on front side of he console. As the front edge of the base panel aligns to the front face of the console, the mounting tabs slide into the grooves provided on the front face of the console to engage the front face of the console thus limiting forward movement of the base panel relative to the console. Then, the locking tab is rotated downward from its upward stowed position so that it is disposed within one of the horizontal grooves provided on the rear face of the console. The locking member is then displaced to prevent rotation of the locking tab thereby firmly securing the display device to the video game console.

Therefore, the video screen unit in accordance with the present invention represents a novel arrangement that is compact and portable and adapted to be conveniently used with the electronic video-processing devices, in particular with the X-Box video game consoles manufactured by Microsoft Corp.

### BRIEF DESCRIPTION OF THE DRAWINGS

Other objects and advantages of the invention will become apparent from a study of the following specification when viewed in light of the accompanying drawings, wherein:

FIG. 1 is a front view of the audio and video accessory for an electronic device according to the present invention.

FIG. 2 is a rear view of the audio and video accessory for an electronic device of FIG. 1.

FIG. 3 is a left side view of the audio and video accessory for an electronic device of FIG. 1.

FIG. 4 is a right side view of the audio and video accessory for an electronic device of FIG. 1.

FIG. 5 is a bottom view of the audio and video accessory for an electronic device of FIG. 1.

FIG. 6 is a top view of the audio and video accessory for an electronic device of FIG. 1.

FIG. 7 is a front and left perspective view of the audio and video accessory for an electronic device according to the present invention.

FIG. 8 is a perspective view of a portable video display unit in accordance with the first exemplary embodiment of the present invention in a stowed position;

FIG. 9 is a perspective view of a portable video display unit secured to a game console in accordance with the present invention in a open position;

FIG. 10 is a rear of the video display unit of the present invention secured to the video game console;

FIG. 11 is an isolated view of the locking mechanism of the game screen prior to locking engagement with the console.

FIGS. 12-13 are partial sectional views taken along line 12-12 of FIG. 11 with the locking mechanism in different configurations during assembly;

FIG. 15 is an isolated partial sectional view taken along line 15-15 of FIG. 9.

### DETAILED DESCRIPTION OF PREFERRED EMBODIMENTS

The preferred embodiments of the present invention will now be described with the reference to accompanying drawings.

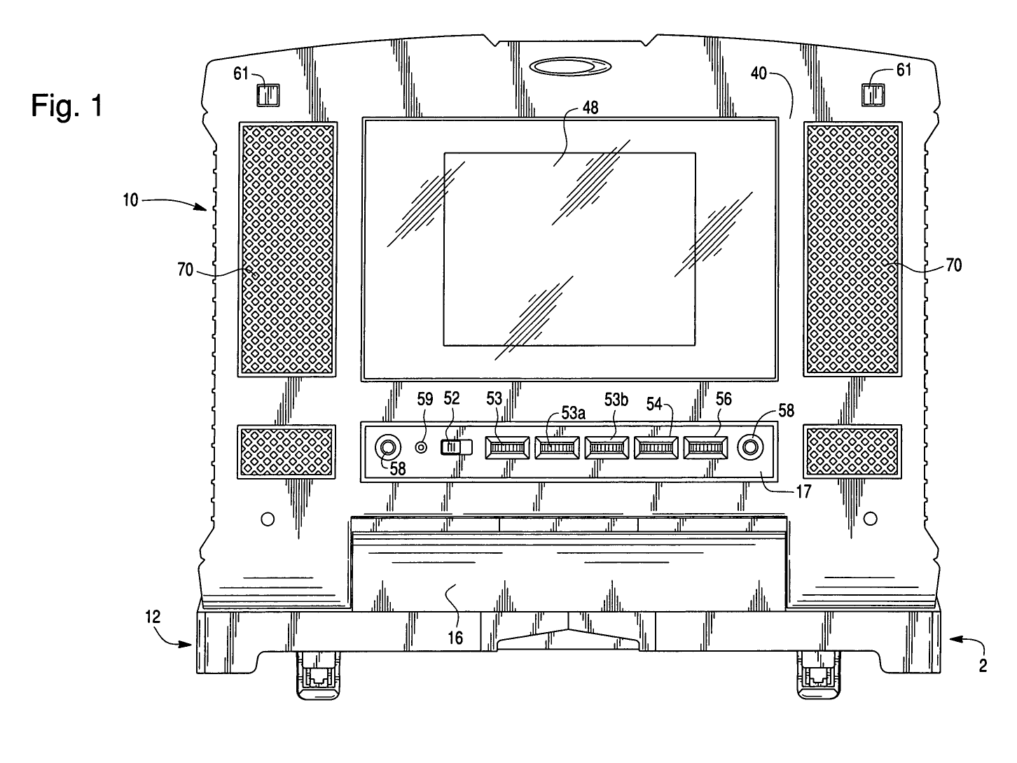

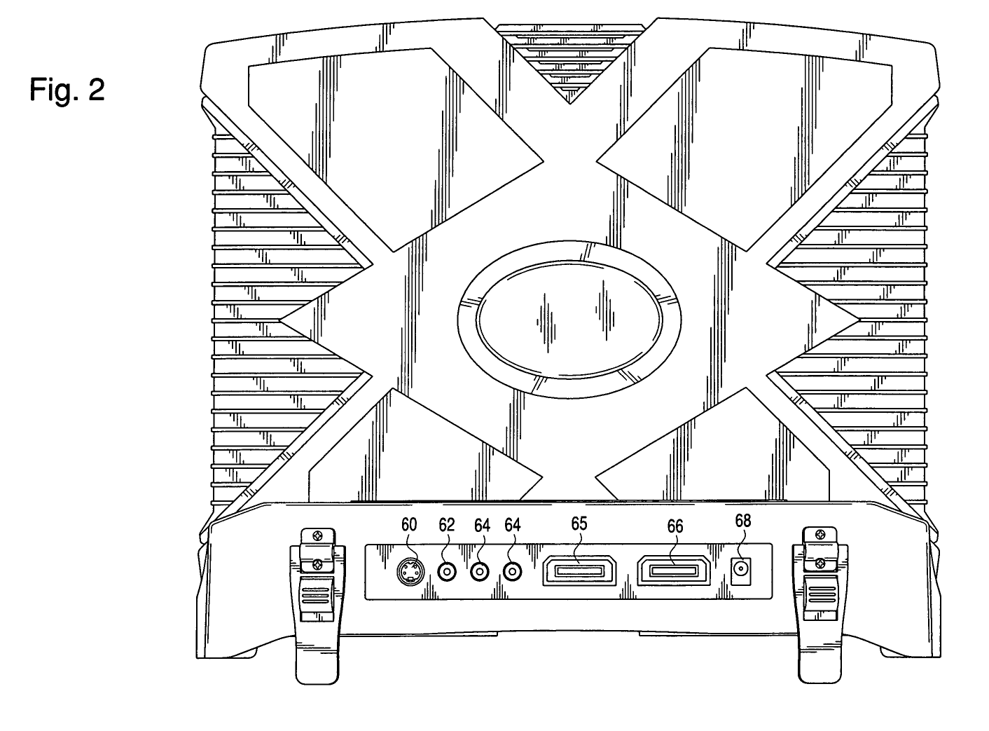

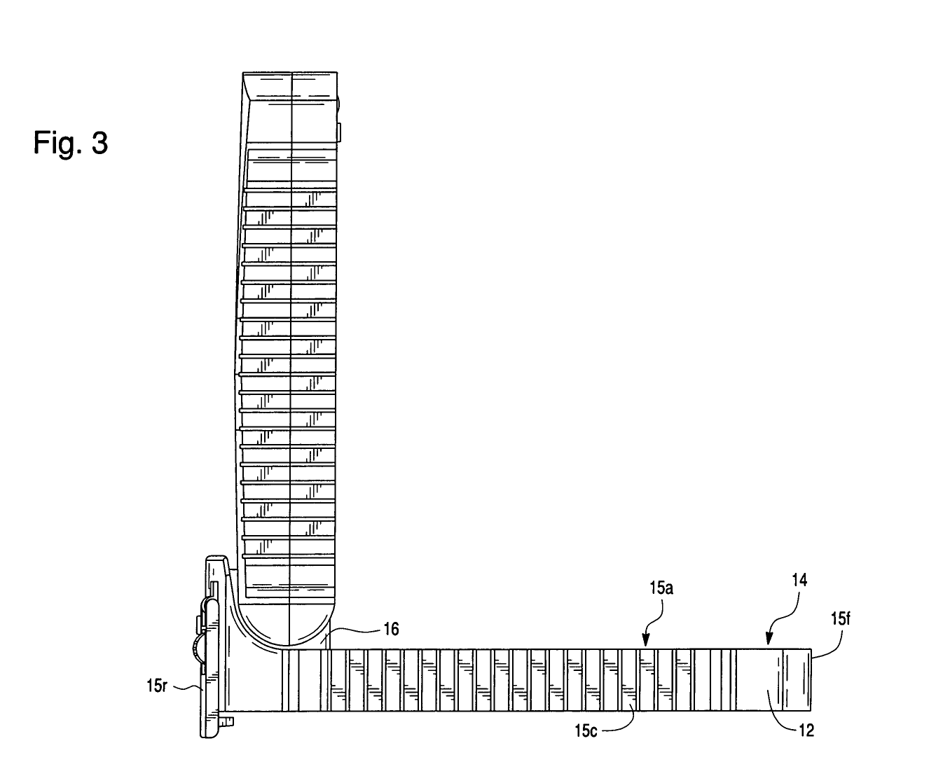

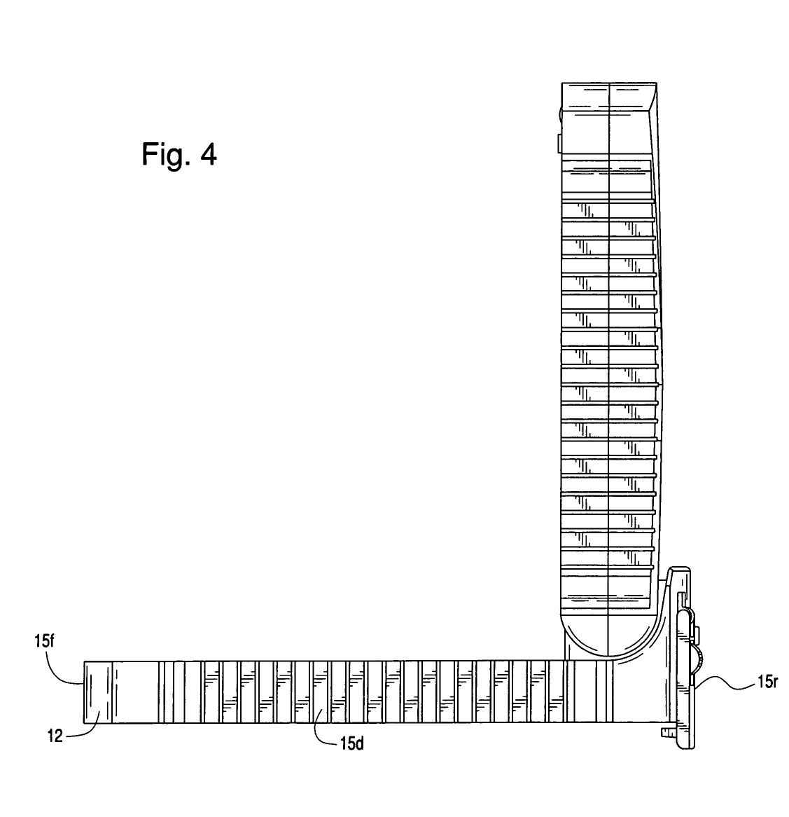

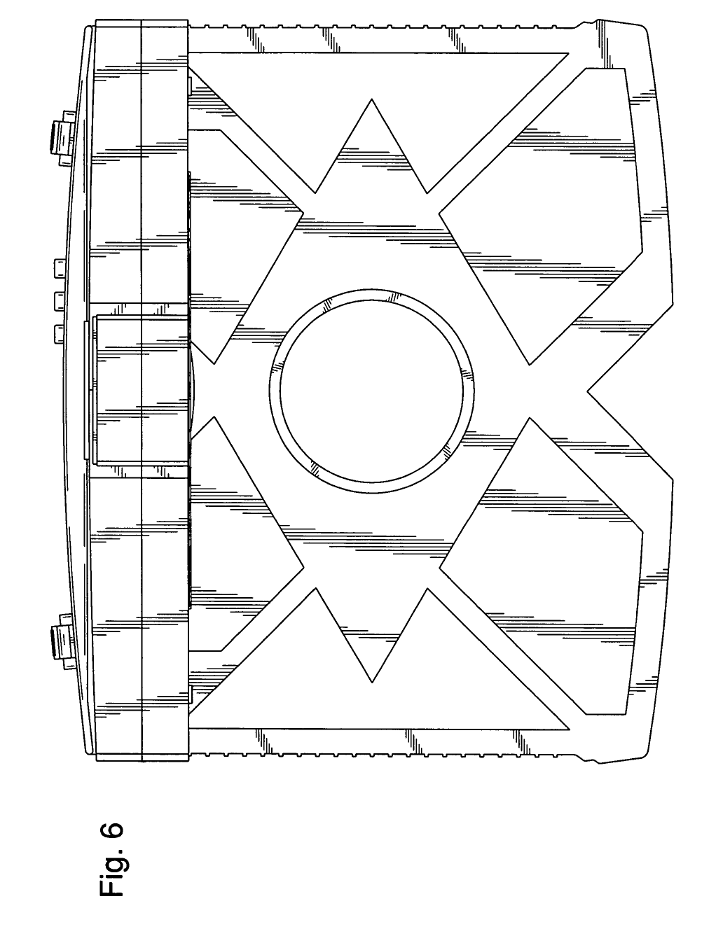

FIGS. 1-8 of the drawings illustrates the video display unit in accordance with the present invention, generally indicated at 10. The video display unit 10 comprises a base member 12 adapted to be removably attached to an electronic video processing device 2, such as a conventional video game console, and a video display member 40 pivotably mounted on the base member 12. An example of a video game consoles include a video game system manufactured by Microsoft known as the X-Box. However, it is to be understood that while the present invention is particularly described and suited for use with the X-Box video game consoles, the present invention is not so limited to this particular device.

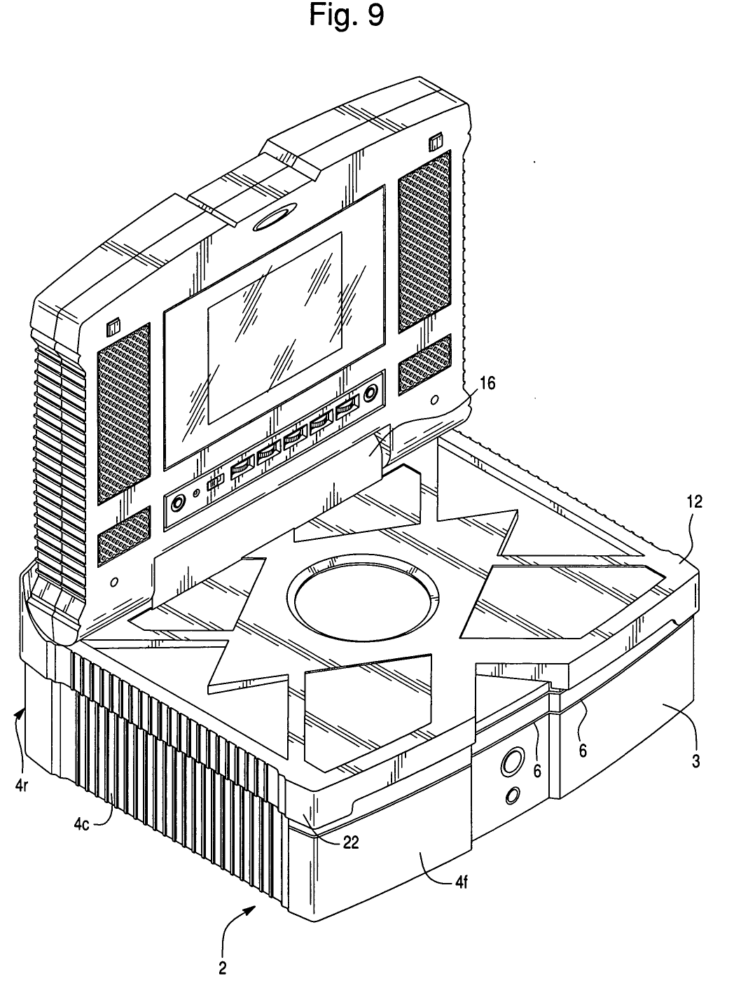

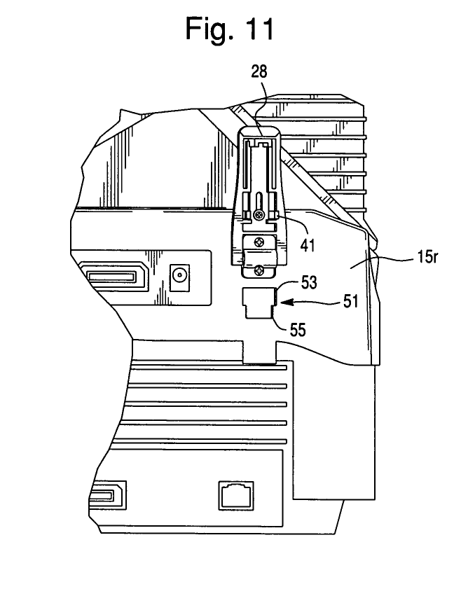

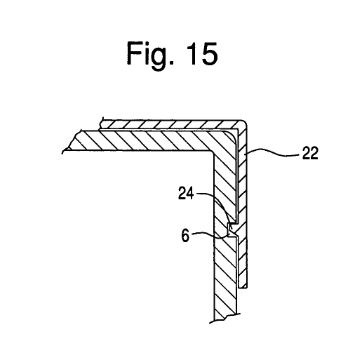

The present invention is illustrated in FIGS. 1-8. The typical X-Box® video game console, generally indicated at 2 and illustrated in FIGS. 9-11, includes a substantially box-like casing 3 having a top surface and a bottom surface, a front face 4f, a rear face 4r, and opposite side faces 4c and 4d. The rear face 4r of the casing 3 of the X-Box® is provided with a plurality of alternating, substantially horizontally extending grooves and ribs 5′ and 5″ respectively. The front face 4f has at least one horizontal groove 6, as illustrated in FIGS. 9, 15.

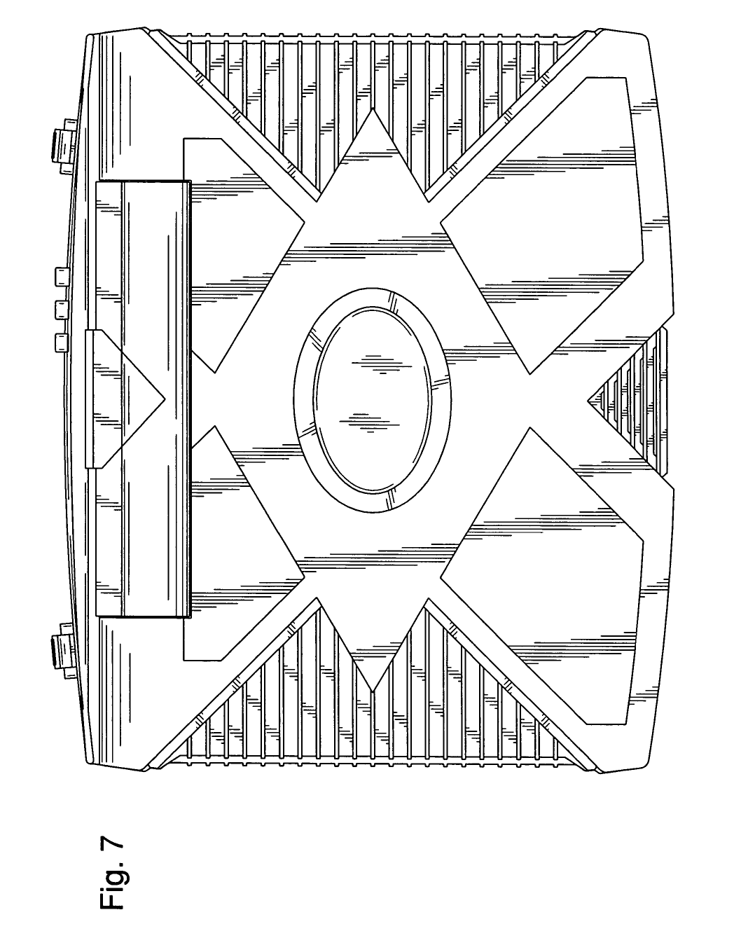

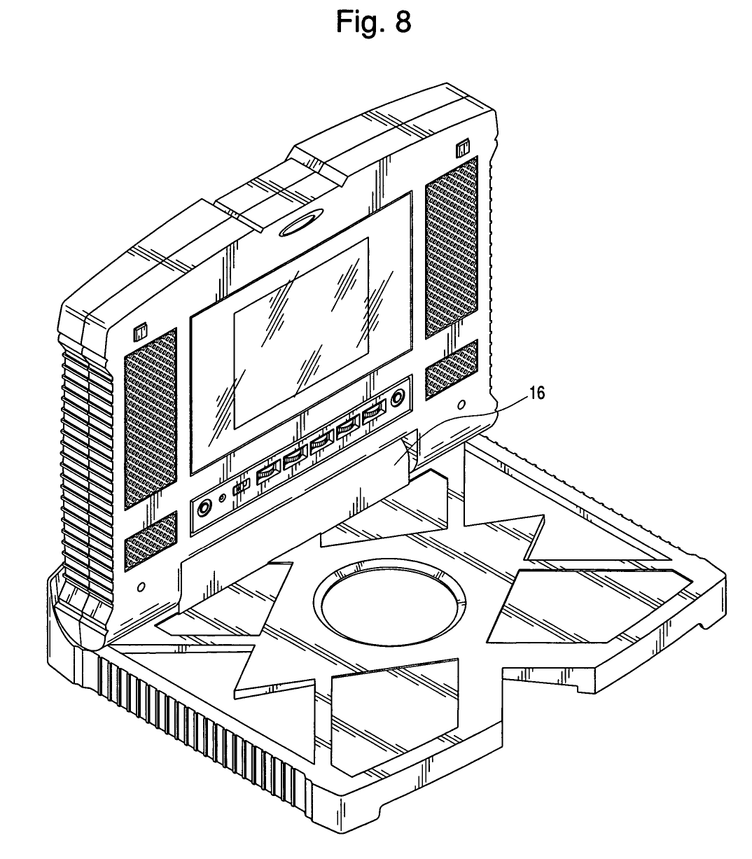

The base member 12 includes a substantially flat base panel 14 having a top surface 15a and a bottom surface 15b, a front edge 15f, a rear edge 15r, and opposite side edges 15c and 15d. The base member 12 further includes a screen support member 16 integrally formed with and upwardly extending from the top surface 15a of the base panel 14 adjacent to the rear edge 15r and extending substantially parallel thereto, as illustrated in FIGS. 1, 8 and 9. The screen support member 16 is adapted for pivotally supporting the video display member 40 between a stowed position (shown in FIG. 7) and a deployed position (shown in FIG. 8).

The display member has a front control panel 17 having for example a power switch 52, a volume control 53, treble control 53a, bass control 53b a screen brightness control 54, a screen color control 56, and earphone plug sockets 58. The rear panel of base member 15r is provided with an S-video input socket 60, a video input socket 62, two audio input sockets 64, an audio/video input 65 output 66, and a socket 68 for a DC/AC adapter (not shown). The sockets 60, 62, 64 and 66 define a screen electrical interface adapted to be operably connected to an electrical interface of the X-Box® video game console and communicate electrical signals there between. Power indicator light 59 (LED) is also provided which illuminates when power is turned on.

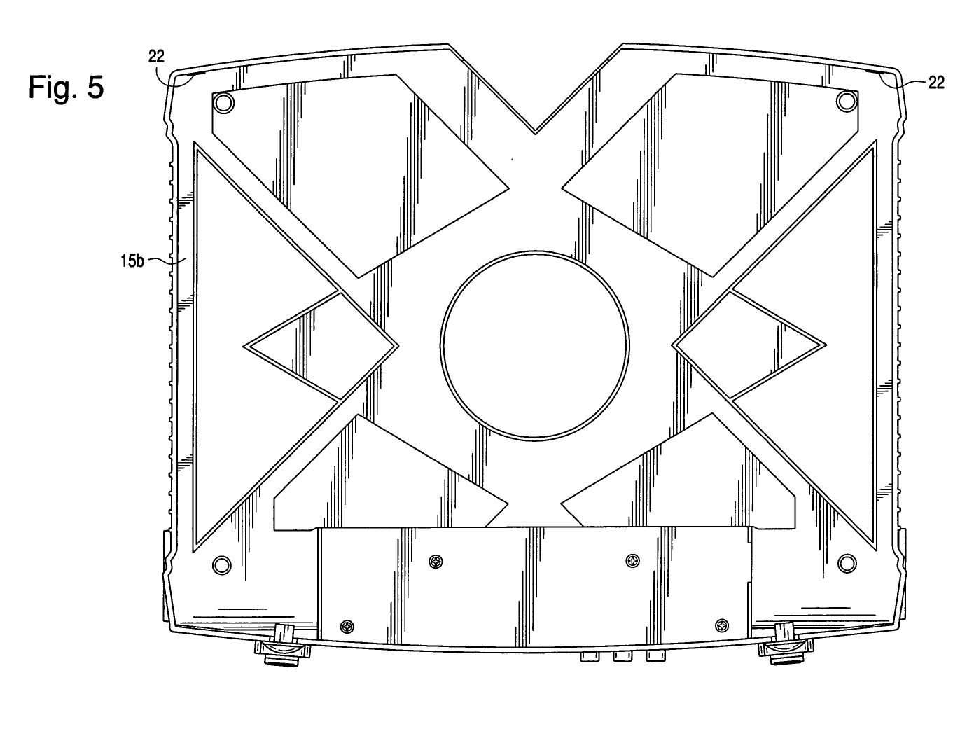

The base panel 14 of the base member 12 further includes a locking attachment device provided for removably securing the video display unit 10 to the video game console 2. The attachment device for the X-Box® video game console 2 includes a guide flange 22 which substantially circumscribes a perimeter of a top portion of the game console 2. A mounting rib 24, extending inwardly from an inner surface of the front face 15f of the guide flange, engages one of two horizontal grooves 6 formed in the front surface 4f of the gaming console. (See FIGS. 15 and 5.)

Preferably, the base panel 14 is Homogeneously formed of strong and durable plastic material as a unitary body integrally with the guide flange 22 and mounting ribs 24 as a single part plastic molding, thus alleviating the cost of assembling multiple components and simplifying its manufacture.

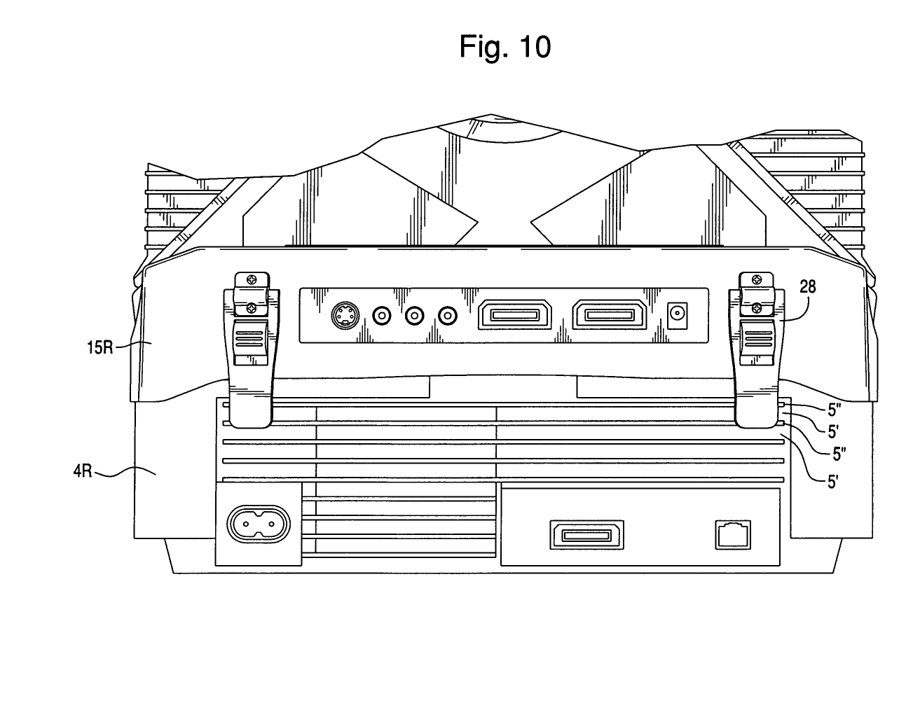

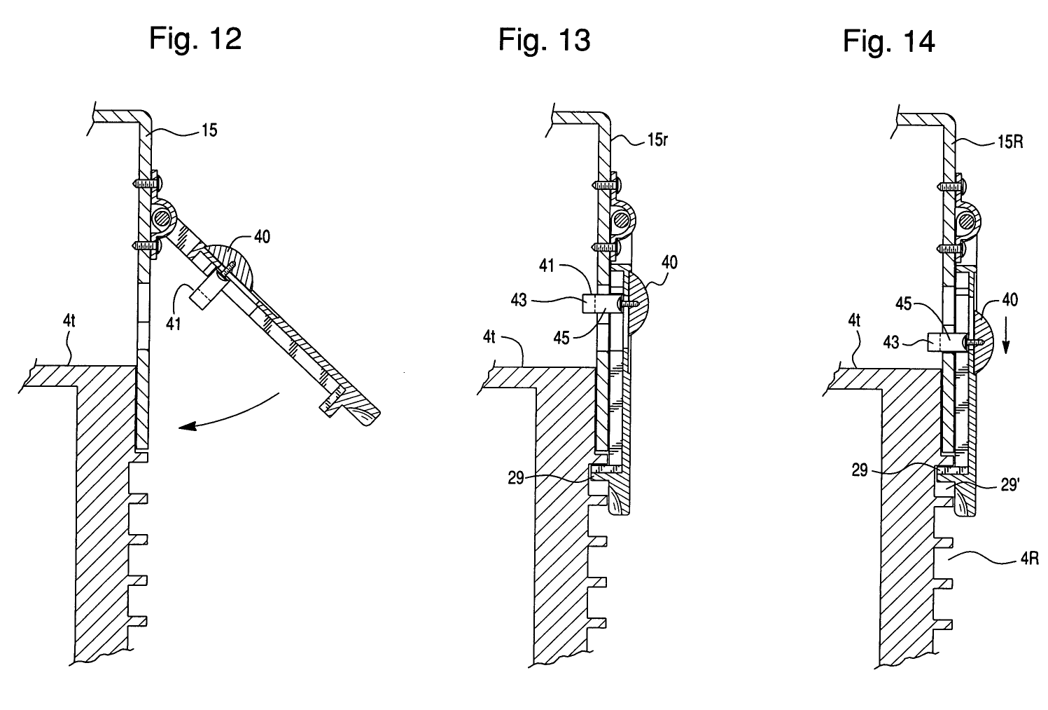

As illustrated in FIGS. 10-14, the rear locking tab 28 is pivotally mounted on the rear surface 15r of the base panel 14 for rotation in a plane substantially perpendicular to the rear surface 15r. The locking tab 28 has a projection 29 disposed within a horizontal groove 29′ (shown in FIGS. 12-14) provided on the rear face 4r of the casing 3 of the X-Box® or other video gaming console. The locking tab 28 releasably locks the video display unit 10 onto the video game console 2 in a discrete predetermined position with respect thereto. When the locking tab is in a locking position (FIG. 14), the engagement of the mounting rib 24 within groove 6 together with the guide flange circumscribing the top of the console 3 and the projection engaging groove 29′, the video display unit is securely fashioned to the console thereby providing a complete portable gaming unit.

In order to lock the locking tab in the locking position, a movable locking member 40 is provided prevent relative rotation of the locking tab 28 relative to the rear surface 15r. A T-shaped hook member 41 is slidably mounted to the locking tab 28. The hook member 41 is shaped so that a wider portion 43 is dimensioned to fit within a wider portion 53 of an opening 51 but larger than a narrow portion 55 the opening 55 in the rear surface 15r. A narrow portion 45 of the hook member is dimensioned to fit within the narrow portion 55 of the opening 51. Operation of the locking member is simple. The locking tab is rotated downward as seen from FIGS. 12-13. The locking member is inserted within the wider portion 53 of the opening 51. The locking member is simply slid downward such that the wide portion 43 of the hook member prevents rotation of the locking tab by interference between the wide portion 43 of the hook member with the narrow portion 55 of the opening 51. Thus because the flange 22 circumscribes the periphery of the video console 2 preventing relative lateral displacement there between, and the locking tab, and projection together with the mounting rib prevent vertical displacement, the video display 10 is firmly secured to the gaming console 3 thus providing a complete portable video gaming and audio video unit.

The video display member 40 includes a hollow display casing made of, preferably, appropriate plastic material. The display casing is pivotally mounted to the screen support member 16 and has a front, viewing surface and a back surface. The display casing houses a display screen 48 viewable on the viewing surface. Preferably, the display screen 48 is a substantially flat liquid crystal display (LCD) screen. The display casing further houses a pair of built-in stereo speakers 70 located on both sides of the LCD screen 48 for providing a stereo sound. Also, a plurality of elastic pad members 61 are provided on the viewing surface of the display casing adapted to provide a small clearance between the video display member 40 and the base panel 14 when the video display unit 10 is in the stowed position.

In use, the video display unit 10 is attached to the casing 3 of the video game console 2 by sliding the base panel 14 over the top surface 4t of the casing 3 so that the guide flange 22 engages the periphery of the console 2, and the mounting ribs slide into and engage grooves 6. As the front edge 15f of the base panel 14 aligns to the front face 4f of the casing 3, the mounting rib 23 of the guide slides into the grooves 6 provided on the front face 4f of the casing 3, thus limiting forward movement of the base panel 14 relative to the casing 3. Then, the locking tab 28 is rotated downward from its upward stowed position so that the projection 29 engages groove 29′ on the rear face 4r of the casing 3, as illustrated in FIGS. 12-14. The locking member is simply slid downward to prevent the locking tab 28 from swinging out of position as illustrated in FIG. 14.

While the foregoing invention has been shown and described with reference to a preferred embodiment, it will be understood by those possessing skill in the art that various changes and modifications may be made without departing from the spirit and scope of the invention. For example it is preferred to form the adjustment collars 11a, 11b and locking collars out of steel. However, other materials of sufficient strength may be employed.

What is claimed is:

1. A portable video display unit comprising:
a base member adapted for removably attaching said video display unit to an electronic video processing device, said base member including a base panel; and
a video display member including a viewing surface provided with a display screen, said video display member pivotally mounted to said base member for pivoting between a stowed position wherein said video display member is substantially parallel to said base panel and a deployed position wherein said video display member projects outwardly from said base panel with said display screen in a disposition which is viewable by a user of said electronic video processing device.

2. The portable video display unit as defined in claim 1, wherein said base member includes a locking attachment device provided for removably securing said video display unit to said electronic video processing device.

3. The portable video display unit as defined in claim 2, wherein said locking attachment device includes a locking tab pivotably mounted to a rear side of said base member, said locking tab including;
a projection engaging a recessed formed in said electronic video processing device,
a movable locking member to selectively prevent rotation of said locking tab relative to said base member to maintain engagement between said projection and said recess.

4. The portable video display unit according to claim 3, wherein movable locking member includes a hook member slidably mounted to said locking tab between a first position and a second position, wherein when in said first position said hook member may be freely and removably inserted within an opening is said base member and when in said second position engages said base member to prevent relative rotation thereto.

5. The portable video display unit as defined in claim 4, wherein said video game console includes a casing having opposite side faces, a front face and a rear face, said front face provided with at least one substantially horizontally extending groove.

6. The portable video display unit as defined in claim 5, further comprising a mounting rib disposed adjacent to a front edge of the base member engaging one of said at least one groove of said front face of said casing of said video game console, and wherein said at least one locking tab engages said rear face of said casing of said video game console.

7. The portable video display unit as defined in claim 6, said at least one locking tab is rotatable in a plane substantially perpendicular to said rear panel of said base member.

8. The portable video display unit as defined in claim 6, including two locking tabs each rotatable in a plane substantially parallel to said rear panel of said base member.

9. The portable video display unit as defined in claim 1, wherein said base member includes a substantially flat base panel and a screen support member extending upward from said base panel adjacent to a rear edge thereof, said video display member being pivotally mounted to said screen support member.

10. The portable video display unit as defined in claim 9, wherein said screen support member has a front panel provided with a power switch and a plurality of controls for regulating said display screen.

11. The portable video display unit as defined in claim 10, wherein said front panel is further provided with at least one earphone plug socket.

12. The portable video display unit as defined in claim 9, wherein said screen support member has a rear panel provided with at least one electrical connector adapted to be detachably electrically connected to a corresponding electrical connector on said electronic video processing device through an extension cable.

13. The portable video display unit as defined in claim 1, wherein said video display member is further provided with a pair of stereophonic loudspeakers.

14. The portable video display unit as defined in claim 1, further comprising a display controller for electrically connecting said video display unit to said electronic video processing device.

15. The portable video display unit as defined in claim 3, wherein said electronic video processing device is a video game console.
